(19) United States
(12) Patent Application Publication
(10) Pub. No.: US 2018/0174474 A1
(43) Pub. Date: Jun. 21, 2018

(54) INTEGRATED LEARNING DEVICE

(71) Applicant: BIOORAM SAGITIM DANISMANLIK VE KOZMETIK ÜRÜNLERI TIC. LTD. STI, Sisli, Istanbul (TR)

(72) Inventor: Ender VARDAR, Istanbul (TR)

(73) Assignee: BIOORAM SAGITIM DANISMANLIK VE KOZMETIK ÜRÜNLERI TIC. LTD. STI, Sisli, Istanbul (TR)

(21) Appl. No.: 15/573,776

(22) PCT Filed: Jun. 22, 2015
(86) PCT No.: PCT/TR2015/050013

§ 371 Date: Nov. 13, 2017

(30) Foreign Application Priority Data
May 14, 2015 (TR) 2015/05840

(51) Int. Cl. G09B 5/06; G09B 19/00

(52) U.S. Cl. CPC G09B 5/06; G09B 19/00

(57) ABSTRACT

Invention item is applied as producing the brain waves of beta, alpha, theta and delta improved by integrating information of modern physiology and psychology that increases learning grade, facilitates and accelerates the learning with its effects to increment of the learning concentration of the brain waves, to remembrance and to development of the memory, then transferring these waves to the person audio-visually in specific periods of time along the learning duration.

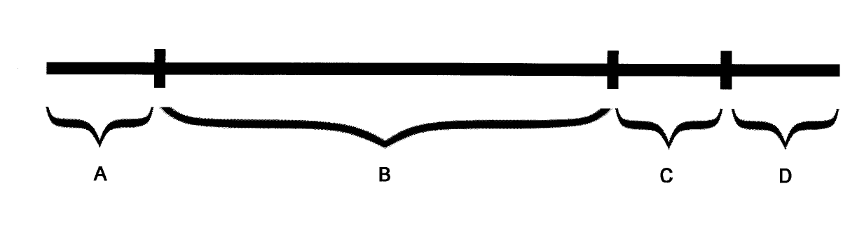

### TECHNICAL FIELD

Invention item is pertinent to the easy, permanent and fast integrated learning system, improved by integrating information of modern physiology and psychology; enhancing, facilitating and accelerating learning level by its effects to improvement of the learning concentration of brain waves, to remembrance and to development of the memory; producing brain waves of beta, alpha, theta audio-visually, then transferring them to the learning person by limited periods along the learning duration.

### INFRASTRUCTURE OF THE INVENTION

Brain is a very complicated structure formed by millions of neurocytes. Activities of neurons are generally very good regulated and they have self-regulating mechanisms. Neurons are responsible for a vast range of functions such as conscience, movement, speech, memory, enthusiasm and posture of the body. These functions have been realized by means of very little amount of electrical charges flowing between brain cells and the all parts of the body.

Functions of body organs are controlled in two ways as hormonal and neural. Hormones are chemical information transmitters and control made by hormones is slow. In case of neurotic control; commands in the situation of neurotic impacts, coded by brain and spinal cord which form Central Neurotic System (CNS) are sent to the organs through nerves thus regulating their activities. Nerves carrying commands from CNS to organs are called “motor nerves” and nerves carrying information from organs to brain are called “sensory nerves”. Nerves outside the CNS, controlling specific sectors of the body are named as “peripheral nerves”.

In addition to many movements and behaviors, brain regulates and supervises homeostatic body functions such as pulsation, blood pressure, liquid balance and body temperature. Functions of brain are responsible for perception, feeling, memory, motor learning and the other learning varieties.

In 1875, in consequence of the experiments on the animals, Caton firstly discovered that there had been some electrical activities in brain. As to Hans Berger, by means of electrodes placed in the head and a galvanometer connected them, he put forth the existence of electrical activities in brain, in the year of 1929. He recorded the rhythmic progresses of the electrical vibrations with an electrode placed into the scalp of his son. He asserted this signal was the instant electro-physiologic response of the cortical brain cell. In 1930, Berger showed that these waves called Electroencephalogram (EEG) had changed with the winking of the eye.

Biologic indicators obtained in consequence of the neurotic activity of the brain are called Electroencephalogram (EEG). EEG is to monitor the brain waves through electrical method. Electrical activity produced by the nerve cells in the brain both when awake and when in sleep is written on the paper as brain waves. As examples of usage fields, neurology as first, and brain surgery, pediatrics, anesthesia, and psychiatry can be given.

EEG wave diagrams as recorded from the regions of the scalp, are generally classified according to their frequencies, amplitudes and shapes. Frequency is the first property used to diagnose the normal or abnormal EEG. Indicators of the EEG are not periodic and their amplitude, frequency and phases varies continuously. Frequency ranges EEG indicators include are as follows:
Delta—δ: 0.5-3.5 Hz
Theta—θ: 3.5-7.5 Hz
Alpha—α: 8-13 Hz
Beta—β: 13-22 Hz
Gamma—γ: 22-30 Hz

Delta Waves:

They are brain waves having frequencies below 3.5 Hz, and amplitude in the range of 20-400 μV. They are slow. They emerge in nurslings, during dead sleep and when brain needs very low activity.

Theta Waves:

They have a frequency between 3.5 and 7.5 Hz. and are classified as “slow” activity. They emerge below the age of 13 and in sleeping children in parietal and temporal regions; in normal individuals they emerge in dreaming sleep. Their amplitudes are less than 100 μV (p-p).

Alpha Waves:

They are the brain waves having frequencies below 8-13 Hz. and they are the most similar to sinusoidal shape. Mostly they are seen in adults, generally in all groups of age. They are seen in awake and quiet people. They emerge intensively in the occipital region and their amplitude is about 50 μV. They disappear in the case of sleeping. If the awake person directs his/her attention towards another activity such as mental arithmetic, stress and opening his/her eyes, Beta waves having higher frequency but lower amplitude occur instead of Alpha waves.

Beta Waves:

Beta activities are “fast”. They are brain waves between 13-22 in frequency and 1-5 μV in amplitude. Concentration and attention in Beta waves between 13-17 Hz are better, however attention is distracted in higher frequencies. In highly stressed situations and when we can't get our heads together and pay attention, brain waves are in Beta wave form above 17 Hz. They are seen as scattered symmetrically in both sides of the brain. They can be recorded specifically from the parietal and frontal regions of the scalp. When stimulated, anxious or having eyes open, dominant rhythm is Beta waves. It is viewed in all groups of age. It is in small amplitude and generally symmetric. They are organized into two as Beta-I and Beta-II.

Gamma Waves:

They are the waves between 22 and 30 Hz frequency. They are used by some researchers, and some use BII waves instead of these. Their amplitude is smaller than 2 μV (p-p). They have the characteristic specification of the sleep.

With present technology, in what sensation and situation people are in which brain waves that are ascertained can be determined easily. Main frequency of EEG indicators and brain activity are closely related. Activity and frequency rise together.

At the present time, both the content of the knowledge increases and gets more and more complex and technologic developments vary and proceed at a high speed. This situation naturally affects the methods of learning and teaching. Performance of the education can be increased in the degree as long as it can take the learning people out of being passive, activate them and enable them to participate in interactivity process. For this reason, most countries interrogate their present education systems in this direction and they are in the struggle to raise individuals who think and solve the problems. To make use of the possibilities of the technologies of education that expedite and improve the learning process, that enable the students to motivate and concentrate and that allow them to learn tastefully and amusedly is one of the effective ways to reach the solution and it will enable standard and to get rid of the monotony.

Every theory in the field of learning deals with the learning in its own perspective and brings a different approach to the process of learning. The theories suggested to explain the nature and results of the learning can be sorted as behaviorist, cognitive, auditory and neurophysiologic or the brain-based theory. Studies and obtained findings in the field of neuroscience have enabled the learning to be described as different from the other theories. Because neurophysiologic theory makes use of the researches in the neuroscience that put forth how the brain works and how the students can learn.

The subject of the invention is the easy, lasting and fast integrated learning system, increasing the level of learning, easing and expediting the learning with its effects on the improvement of learning concentration on the remembrance and on the enhancing of the memory, developed by integrating information modern physiology and psychology, producing beta, alpha, theta and delta waves of the brain and transmitting these waves audio-visually with specific periods to the person along the process of learning. Learning is described to become able to do something that was not possible to be done before. In the known situation of the technics, for the synthetic webs of nerve; three methods of learning and different rules of learning where these apply.

In supervised learning, a teacher helps for the educating system to be learned. The teacher gives the examples relating to the subject necessary to be learned as an input/output set. It means that input set and most appropriate output to that is definite beforehand. By estimating the difference between the outputs given as example and desired and by changing until most suitable output is obtained, the result is attained with minimal error.

In unsupervised learning, there is not a teacher to help for the system to be learned.

Only values input into the system is shown. It is expected for the system itself to determine the rules and the relations between parameters in the examples.

In supportive learning, the teacher only assists in the system. Instead of showing/giving the output corresponding each input set, it produces a signal to crosscheck the output of the system. The system regulates the learning process in accordance with this signal coming from the teacher.

In scholastic learning, in order to activate the neurons in the system to be educated, thus to enable them to obtain the desired output, they are brought together. This way, probability for the neurons to be activated rises.

As for mixed strategies, they are the methods that use a few procedures of the learning combinedly.

In relation to how the visualization techniques can be used in learning and in what grade they can be successful; assertive inferences have not been made in the known technique; however, specific studies have been carried out, even if limited. These studies consist of the brain imaging studies made in different fields (mathematics, music, reading and language skills and brain reading etc.). For example, in last a few years, brain imaging techniques have been used to obtain information about neurotic development of the reading and language skills in the children. In the field of reading, findings obtained from various brain imaging techniques (PET, fMRI) have been merged and this way nerve webs related to phonologic (pertaining to science of sound) processing and word recognizing have been determined. While performing this process, neural activities of the children with overachievement and underachievement have been analyzed and specific differences between them have been determined. According the consequence of this study made about the reading and language skills; in addition to the consideration of the problem as being biologically based, complicated interactivities have been viewed between the region related to the reading field situated in the brain and social surrounding.

Improved invention item; integrated learning system is a combination of three factors formed with right and left cerebral hemispheres and the compatibility of the relaxed body. Combination of these three factors aims at faster and permanent learning by having advantage over the known situation of the technics. Playing of the wind, percussion and stringed instruments harmoniously in an orchestra can be given as an example to the combination of these three factors. Right cerebral hemisphere learns by picture, music, instinct, intuition and imagination, in the meaning of by using sub-conscience; while left cerebral hemisphere learns with logic, conscience and by analyzing. Main point of the invention item learning system is based on the working of left cerebral hemisphere, right cerebral hemisphere and the human body in accordance.

With the discovering of the processing of the brain, to overcome the learning problems encountered in the human life is the main purpose of the invention. Together with this purpose, equipments able to accelerate the learning of the people by being integrated will become a part of the activity at the stage of the application of the system. To rearrange the education and training programs that is necessary to give to the people who suffers from learning disability or who are not disable but target at learning faster, easier and permanently, revising them in the direction of the brain waves data and put them into practice are from the goals of mentioned invention system item.

Left cerebral hemisphere sometimes analyzes excessively, so it can develop negative beliefs. This may cause to believe that learning is a difficult, troublesome, and stressed process and may bring the learning to a standstill. Besides, if the body is not relaxed, the sympathetic autonomous nerve system of the brain activates and secreted stress hormones such as adrenalin and cortisol, contract the veins, affects the blood flow of the brain negatively and thus learning may be prevented. Human brain thinks with pictures and recalls with set connections. When picture, music, rhythm, relaxation and imagination that activate right cerebral hemisphere and sub-conscience brain are attached to the learning, quality of learning increases. With using the conscious intelligence and sub-conscious intelligence together in the learning, invention item integrated learning system can be used in all processes such as learning languages, mathematics, chemistry, history, tennis, ski, etc. The system mentioned makes the learning enjoyable. Psychotherapy methods such as ego supportive therapies and positive suggestions have been attached to the learning process. Unstressed and joyous learning is aimed at. In order to make the brain one which emits brain waves in case the learning is best, it is necessary to use a device that produces these waves as sound and image together with the system. With this device, the person will be brought to the beta brain wave mode in which the concentration is the optimum, to the alpha and theta wave modes in which the learning is the optimum and to the delta brain waves mode in which the memory is the optimum, and at that time the material will be processed with specific paced music, image, animations, rhythmic slow respiration, special reading speed and reiterations. To overcome the psychological obstacles is very important in learning. Those who think the way “Others can do, but I cannot succeed”, “I was not able to learn up to now, and still I am not able to learn”, and those who have heard for years from their families, and their friends that they had not been clever enough may restrict themselves. Also, some people may be conditioned to that learning is troublesome and difficult. In this learning system special relaxing music, images and affirmations given in case of quiet consciousness of the brain when it emits alpha waves are more effective and learning will be easier with the suggestions that are ego supportive and regulatory for the self-image of the person. Because stress, trouble, negative thoughts and feelings do not consume our energy, achievement will increase. Besides, when the student sees that he/she can learn easily and can recall in very first lesson, self-confidence of him/her will rise and with the avalanche effect, learning will improve increasingly every day.

With ego supportive works, by making suggestions such as “I am learning easily, I am recalling easily, I am succeeding easily, I enjoy learning” instead of studying with restricting negative beliefs such as “I cannot succeed, I cannot learn”, the potential for learning within us will be maximized. During the lesson, lessons will be given in company with special melodies containing beta, alpha and theta waves, in a specific narration tone, with picture and animations and they will be repeated. Besides, in the meantime, by rhythmic respiration suggestions of the teachers, their recollection abilities will be improved.

Structural and characteristic features and all advantages of the invention will be understood clearer by means of the detailed explanation below and for this reason, this evaluation should be carried out by taking this detailed explanation into consideration.

### FIGURE AUXILIARY TO EXPLANATION OF THE INVENTION

The sole FIGURE is a symbolic image of the stages of the integrated learning system.

### REFERENCES AUXILIARY TO EXPLANATION OF THE INVENTION

A. Section A

B. Section B

C. Section C

D. Section D

Explanation of the Invention

Invention item; easy, lasting and fast integrated learning system is applied with effects of the brain waves to learning concentration, recollection and improvement of the memory, thus it increases the learning grade, eases and accelerates the learning; it is developed through integrating modern physiological and psychological knowledge; it produces beta, alpha, theta and delta waves of the brain and transmits these audio-visually to the learning person in specific periods along the learning duration.

Application of the easy, permanent and fast integrated learning system is realized by applying the steps below:
Providing deep relaxation through physical and psychological relaxation technique,
Making positive suggestions for better learning,
Monitoring and listening to the material to be learned in company with the audio-visual frequencies loaded with special brain frequencies, with every kind of device, eye-glasses, cabinet or screen in the environment where attention of the person will not be distracted and reiteration of the information learned.

The sole FIGURE shows the symbolic image of the stages of the integrated learning system. The system of the invention item is composed of four stage as section A (A), section B (B), section C (C), and section D (D).

Section A (A) is the 5-15 minute preparation phase for easy, fast and permanent learning in the chapter to begin to express the material to be learned. In the section A (A), person/people is/are made ready for the easy and fast reading with deep relaxation through physical and psychological relaxation technique in company with the audio-visual frequencies containing alpha and theta waves in case that brain becomes comfortable and open for learning; and with affirmations making the learning and recollecting easier, suggestions, a special tone of voice and rhythm and respirational rhythm.

Section B (B) is the second section that concentration increases in case the system is applied. In section B (B), between 20-40 minutes, in company with the special beta waves, content of the learning prepared specifically is monitored and listened to in the provided environment where the person's attention is not distracted as eyes open with every kind of devices, eyeglasses, cabinet or screen and sometimes this process is reiterated with special intervals as eyes closed, in company with the alpha and theta brain waves through which brain can learn best, with a special tone of voice and rhythm and respirational rhythm.

In section B (B), all kinds of content to be learned will be prepared with audio-visual animations and techniques improved for easy and amusing learning and will be added to the device to be integrated into the system through a firmware.

Section C (C) is the section where the specially prepared content education taught in section B (B) is reiterated with the alpha and theta brain waves through which brain can learn best as eyes closed for some 5-10 minutes, in company with audio-visual frequencies, with a special tone of voice and rhythm and respirational rhythm, following the obtainment of deep relaxation through physical and psychological relaxation technique as stated in section A (A).

As for section D (D), it is the section where the specially prepared content education taught in section B (B) is reiterated with delta brain waves through which memory function of the brain becomes best as eyes closed for some 5-10 minutes, in company with audio-visual frequencies, with a special tone of voice and rhythm and respirational rhythm, following the obtainment of deep relaxation through physical and psychological relaxation technique stated in section A (1).

Section C (C) and Section D (D) may be combined and applied as one section as well.

The process steps mentioned in the claim have been restricted in order to make the understanding of the method easier only, therefore it should be taken into consideration that these may vary according to the feature of the device that is used and the other variable conditions. It should not be considered that these steps of process restrict the content of the invention item of integrated learning system. It is obvious that a person who is an expert in technics may put the innovation forth which put forth in the invention by using similar structures and/or he/she may apply this structure to the other fields having similar purpose used in related technics as well. Therefore, it is also apparent that this type of structures will be deprived of the criterion of surpassing the known situation of the innovation and especially technics.

1. The invention pertains to the method in relation to application of easy, permanent and fast integrated learning system, applied in the way that enhances, facilitates and accelerates learning level by its effects to improve the learning concentration of brain waves, to remembrance and development of the memory and which is improved by integrating information of modern physiology and psychology and through which produced brain waves of beta, alpha, theta is audio-visually transferred to the learning person by limited periods along the learning duration, comprising these step processes;
obtainment of deep relaxation through physical and psychological relaxation technique,
making affirmative suggestions for better learning,
reiteration of information learned, hearing and watching with every kind of devices, eyeglasses, cabinet or screen in the provided environment where the person's attention is not distracted in company with audio-visual frequencies as special brain frequencies loaded of the material to be learned,
wherein it consists of these four steps;
division A comprising the processes of making the person/people ready for easy and fast learning with affirmations, inspirations, a special tone of voice, rhythm and breathing rhythm that eases the deep relaxation, learning and remembrance through physical and psychological relaxation technique in company with audio-visual frequencies that includes alpha an theta waves in that the brain relaxes and becomes open to learning for 5-15 minutes in the section of the beginning explanation of material to be learned,
division B comprising between 20-40 minutes, the processes of hearing and watching of the education content specially prepared in company with particular beta waves that increase the concentration and attention with every kind of devices, eyeglasses, cabinet or screen with the eyes open in the provided environment where the person's attention is not distracted and reiteration with a particular tone of voice, rhythm and breathing rhythm in company with the alpha and theta brain waves that the brain is able learn optimally with particular periods eyes closed,
division C comprising pursuant to obtainment of deep relaxation through physical and psychological relaxation technique in division A, the processes of reiteration of specially prepared education content taught in division B with a particular tone of voice, rhythm and breathing rhythm in company with audio-visual frequencies of alpha and theta waves that the brain is able learn optimally for about 5-10 minutes eyes closed and
composition of four stages including division D that comprising pursuant to obtainment of deep relaxation through physical and psychological relaxation technique in division A, the processes of reiteration of specially prepared education content taught in division B with a particular tone of voice, rhythm and breathing rhythm in company with audio-visual frequencies of delta waves that the brain has optimum memory function for about 5-10 minutes eyes closed.

2. The integrated learning system according to claim 1, comprising addition of a software to the device in which the system will be integrated through preparing developed techniques for easy and entertaining learning of every kind of content, audio-visual animations to be learned in division B.

3. The integrated learning system according to claim 1, comprising applicability in single division by composing the processes in division C and in division D.

4.-8. (canceled)
